(19) United States
(12) Patent Application Publication
(10) Pub. No.: US 2012/0278336 A1
(43) Pub. Date: Nov. 1, 2012

(54) REPRESENTING INFORMATION FROM DOCUMENTS

(76) Inventors: Hassan H. Malik, Monmouth Junction, NJ (US); Vikas S. Bhardwaj, Jersey City, NJ (US); Huascar Fiorletta, New York, NY (US); Armughan Rafat, Franklin Park, NJ (US)

(21) Appl. No.: 13/097,619

(22) Filed: Apr. 29, 2011

(51) Int. Cl. G06F 17/30

(52) U.S. Cl. 707/748; 707/E17.008

(57) ABSTRACT

Systems and techniques are disclosed for representing information included in unstructured text documents into a structured format. The systems and techniques identify events and information associated with the events in unstructured documents, classify the identified events and information, and represent the identified events and information in a structured format based on a computed classification score. The systems and techniques may also assign a confidence score to identified events, compare the confidence score associated with events to a confidence score associated with a trained confidence model, and represent the identified events and information associated with the events in a structured format based on the comparison.

### TECHNICAL FIELD

This disclosure relates to representing information from unstructured information, and more particularly to systems and methods for automatically representing information from unstructured documents in a structured format.

### BACKGROUND

Today there is an increasing amount of information, predominantly in the form of unstructured textual data included in documents, which is relevant to an investor's decision making process. While this information is voluminous, the effort by which an investor needs to identify terms and comprehend the semantics included in these documents can be painstaking. Although the electronic storage of documents has simplified the process of browsing through multiple and large documents, it remains difficult and time-consuming to browse through large volumes of text to understand and quickly locate information of interest.

For example, corporate press releases typically identify corporate financial events, such as dividends, earnings per share, management and ownership structure, etc., in unstructured (e.g., free form) text along with additional information. Parsing through this information to identify items of interest is a time consuming process. Further, while most word processing tools do provide a mechanism for searching individual terms in a document, none of these tools provide supplemental information accompanying items of interest.

Accordingly, there is a need for improved systems and techniques for providing information, such as facts and events, from unstructured data.

### SUMMARY

Systems and techniques are disclosed for representing information included in unstructured text documents in a structured format. The systems and techniques identify events and information associated with the events in unstructured documents, classify the identified events and information, and represent the identified events and information in a structured format based on a computed classification score. The systems and techniques may also assign a confidence score to identified events, compare the confidence score associated with events to a confidence score associated with a trained confidence model, and represent the identified events and information associated with the events in a structured format based on the comparison.

Various aspects of the systems and techniques relate to computing probability values and combining probability values to generate a classification score.

For example, according to one aspect, a method includes identifying attributes of an event included in an unstructured text document, each of the identified attributes similar to at least one event attribute included in a set of pre-defined event attributes, generating document features for each of the identified attributes, and applying at least one of a plurality of classifiers to each of the generated features. The at least one classifier previously trained using a pre-defined event attribute corresponding to the identified event attribute.

The method also includes computing a probability value from a classifier score generated by the at least one classifier using a probability estimation model, the probability value indicating a likelihood of the identified event attribute corresponding to one of the set of pre-defined event attributes, combining a plurality of computed probability values associated with the identified attributes to generate a classification score, and representing, from the unstructured text document, the event and the identified attributes into a structured format based at least in part on the classification score.

In one embodiment, the method further includes assigning a confidence score to the event using at least one confidence model, comparing the confidence score associated with the event to a confidence score associated with a trained confidence model, and representing, from the unstructured text document, the event and identified attributes in the structured format based on the comparison.

In yet another aspect, a method includes accessing an unstructured text document to identify an event and a set of attributes associated with the event, the set of attributes being related to a set of predefined event attributes, and generating a set of document features associated with the set of attributes, the set of document features having a higher number of set elements than the set of attributes. For a first document feature in the set of document features, the method includes generating a first classifier score, the first classifier score being generated with a classifier having been previously trained using the set of predefined event attributes, and based upon the first classifier score, computing a first probability value using a probability estimation model, the first probability value indicating a likelihood that a first event attribute from the set of event attributes corresponds to the set of predefined event attributes.

The method also includes, for a second document feature in the set of document features, generating a second classifier score, the second classifier score being generated with the classifier, and based upon the second classifier score, computing a second probability value using the probability estimation model, the second probability value indicating a likelihood that a second event attribute from the set of event attributes corresponds to the set of predefined event attributes.

The method further includes generating a classification score using a first probability value and the second probability value, and based upon the classification score, representing from the unstructured text document, the event and the set of attributes in a structured data format.

A system, as well as articles that include a machine-readable medium storing machine-readable instructions for implementing the various techniques, are disclosed. Details of various implementations are discussed in greater detail below.

Additional features and advantages will be readily apparent from the following detailed description, the accompanying drawings and the claims.

### BRIEF DESCRIPTION OF THE DRAWINGS

FIG. 1 is a schematic of an exemplary computer-based system for representing information from an unstructured text document.

FIG. 2 illustrates an exemplary method for training the computer-based system shown in FIG. 1.

FIG. 3 illustrates an exemplary method for representing information from an unstructured text document.

FIG. 4 illustrates an exemplary user interface for training the computer-based system of FIG. 1.

Like reference symbols in the various drawings indicate like elements.

### DETAILED DESCRIPTION

The present invention includes methods and systems which facilitate automatic extraction (e.g., representation) of events (e.g., facts) and identified attributes of events (e.g., information relating to the events) from unstructured data into a structured data format. Examples of unstructured data that may be used with the present invention include, but are not limited to, books, journals, documents, metadata, health records, financial records, and unstructured text such as news reports, a corporate press release, the body of an e-mail message, a Web page, as well as word processor documents.

Structured data formats specify how data is to be organized and include rules that standardize the structure and content of information. Example structured data formats generated by the present invention include, but are not limited to, eXtensible Markup Language (XML), eXtensible Business Reporting Language (XBRL), Hypertext Markup Language (HTML), and other data formats having a published specification document.

The methods and systems are particularly beneficial in scenarios in which a financial event is included in unstructured text along with multiple other facts, some of which relate to the financial event and some of which do not relate to the financial event.

For example, a corporate press release may include an event such as a stock dividend announcement that has associated with it a period of time in which the stock dividend is payable and an entity name identifying the business concern paying the stock dividend, which is of interest to a market professional. The press release may also include additional information unrelated to the dividend event, such as new employee benefit information, which may be of less interest to the market professional. Using the present invention, the market professional does not need to spend the time reading the entire press release and culling through the new employee benefit information, as the dividend and related information which is of interest to the market professional can be automatically provided to the market professional in one of several structured data formats.

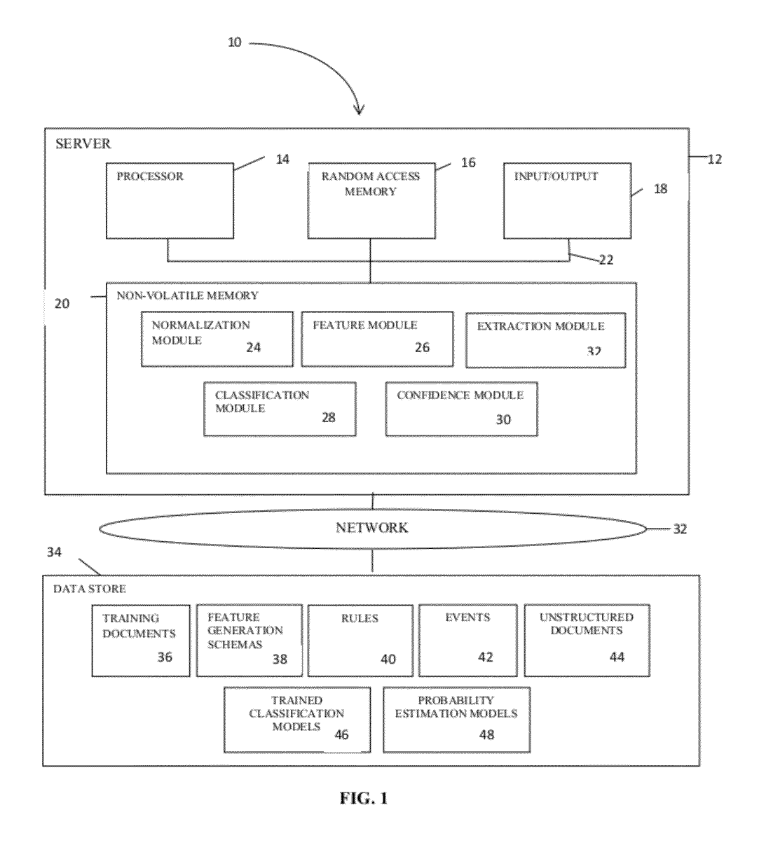

Turning now to FIG. 1, an example of a suitable computing system 10 within which embodiments of the present invention may be implemented is disclosed. The computing system 10 is only one example and is not intended to suggest any limitation as to the scope of use or functionality of the invention. Neither should the computing system 10 be interpreted as having any dependency or requirement relating to any one or combination of illustrated components.

For example, the present invention is operational with numerous other general purpose or special purpose computing consumer electronics, network PCs, minicomputers, mainframe computers, laptop computers, as well as distributed computing environments that include any of the above systems or devices, and the like.

The invention may be described in the general context of computer-executable instructions, such as program modules, being executed by a computer. Generally, program modules include routines, programs, objects, components, data structures, loop code segments and constructs, etc. that perform particular tasks or implement particular abstract data types. The invention can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art can implement the description and figures as processor executable instructions, which can be written on any form of a computer readable media.

In one embodiment, with reference to FIG. 1, the system 10 includes a server device 12 configured to include a processor 14, such as a central processing unit (‘CPU’), random access memory (‘RAM’) 16, one or more input-output devices 18, such as a display device (not shown) and keyboard (not shown), and non-volatile memory 20, all of which are interconnected via a common bus 22 and controlled by the processor 14.

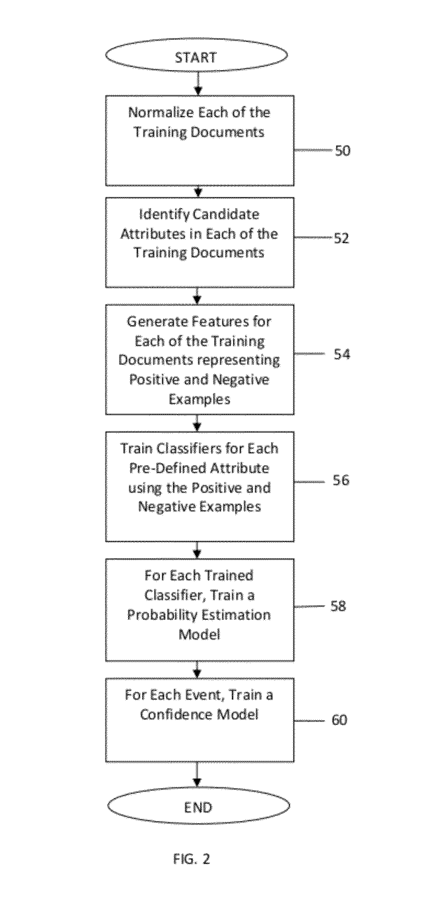

As shown in the FIG. 1 example, in one embodiment, the non-volatile memory 20 is configured to include a normalization module 24 for identifying, from an unstructured text document, attributes of an event, such as currencies, financial qualifiers, time periods, delimiters, entity names, and other items of significance in the financial domain, a feature module 26 for generating document features (e.g., numerical vectors) that describe items, such as words, terms, punctuations, etc., that occur in the unstructured text document, a classification module 28 for categorizing a set of document features and assigning a classification score to items that occur in the unstructured text document, a confidence module 30 for determining an accuracy in identifying the event from the unstructured text document, and an extraction module 32 for representing the event and any identified attributes of the event from the unstructured text document in a structured data format. As used herein, the words ‘set’ and ‘sets’ refer to anything from a null set to a multiple element set. Additional details of these modules 24, 26, 28, 30 and 32 are discussed in connection with FIGS. 2, 3 and 4.

A network 32 is provided that can include various devices such as routers, server, and switching elements connected in an Intranet, Extranet or Internet configuration. In one embodiment, the network 32 uses wired communications to transfer information between an access device (not shown), the server device 12, and a data store 34. In another embodiment, the network 32 employs wireless communication protocols to transfer information between the access device, the server device 12, and the data store 34. In yet other embodiments, the network 32 employs a combination of wired and wireless technologies to transfer information between the access device, the server device 12, and the data store 34.

The data store 34 is a repository that maintains and stores information utilized by the before-mentioned modules 24, 26, 28, 30 and 32. In one embodiment, the data store 34 is a relational database. In another embodiment, the data store 34 is a directory server, such as a Lightweight Directory Access Protocol (‘LDAP’). In yet another embodiment, the data store 34 is an area of non-volatile memory 20 of the server 12.

As shown in the FIG. 1 example, in one embodiment, the data store 34 includes a set of training documents 36 that are used by the classification module 28 to train multiple binary classifiers on event attributes, a plurality of feature generation schemas 38 are provided that are applied by the feature module 26 to generate document features for the set of training documents 36 and the set of unstructured documents 44, and a set of pre-defined rules 40 are provided that are applied by the classification module 28 if an attribute included in one of a set of unstructured documents is positively identified.

The data store 34 also includes a set of pre-defined events 42. Each one of the pre-defined events 42 includes at least one pre-defined event attribute associated therewith. For example, in one embodiment, a pre-defined event entitled ‘Dividend’ has associated with it the following predefined event attributes: an amount, a period, and a qualifier. In one embodiment, each of the pre-defined event attributes is associated with a unique identifier in the system. The data store 34 also includes one or more trained confidence models 46 that provide an accuracy determination of events identified in the set of unstructured documents 44, which in one embodiment, may include one or more news items received over a real-time data feed, and probability estimation models 48 to compute probability values from classification scores computed by the classification module 28. Additional details of the information included in the data store 34 are discussed in greater detail below.

Although the data store 34 shown in FIG. 1 is connected to the network 32, it will be appreciated by one skilled in the art that the data store 34 and/or any of the information 36-48 shown in FIG. 1, can be distributed across various servers and be accessible to the server 12 over the network 32, be coupled directly to the server 12, or be configured in an area of non-volatile memory 20 of the server 12.

Further, it should be noted that the system 10 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input is communicated to the computing device via an input device, such as a keyboard and/or mouse. Data output of the system is communicated from the computing device to a display device, such as a computer monitor.

Turning now to FIG. 2, an example method for training the computer-based system shown in FIG. 1 is disclosed. First, at step 50, the normalization module 24 normalizes each document in the set of training documents 36. In one embodiment, normalization of each document includes identifying tokens of significance (e.g., words, phrases, sequences of letters, numbers and special characters) from the financial domain for each of the set of training documents.

Next, at step 52, the normalization module 24 identifies candidate attributes in each of the training documents. As used herein, the term ‘candidate attribute’ refers to a word, phrase, or other token of significance that may relate to a pre-defined attribute associated with one of the pre-defined events 42 in the system. For example, in one embodiment, candidate attributes include, but are not limited to, currencies, financial qualifiers, time periods, delimiters, and entity names included in each of the training documents. The normalization module 24 then assigns each identified token of significance a unique identifier within each training document.

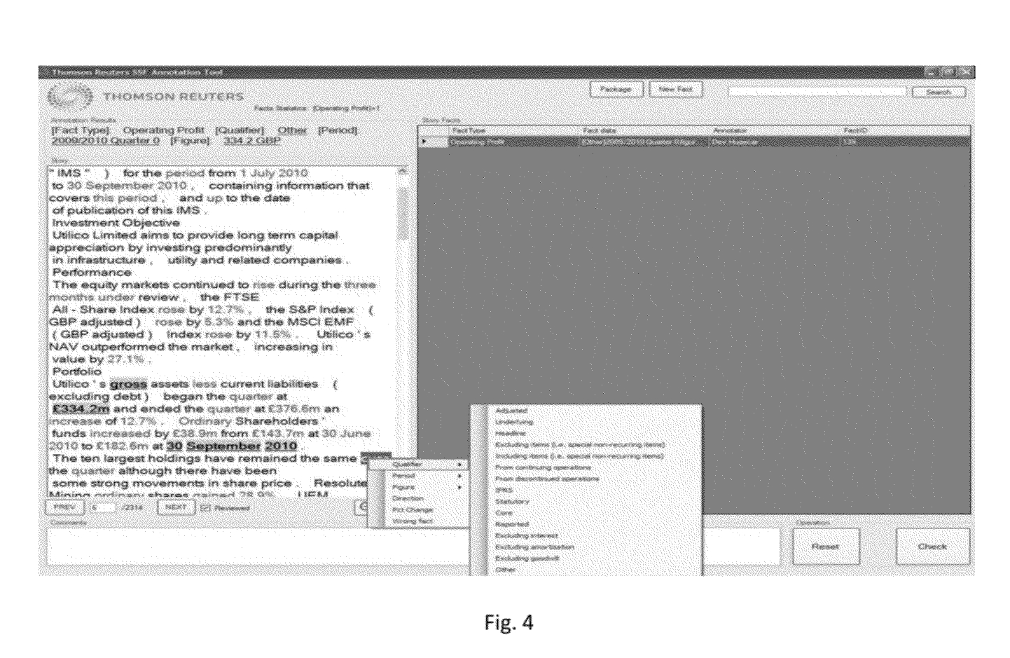

Referring to FIG. 4, in one embodiment, the normalization module 24 provides a user interface that displays each normalized training document to a user, such as a human expert. The normalization module 24 displays each identified candidate attribute as a marked-up/tagged portion of text within each training document. As shown in the FIG. 4 example, the expert may identify marked-up/tagged portions of text, represented in the system by the unique identifier, that are positive for (e.g., correspond to) any attribute in the set of pre-defined event attributes associated with events 42. The normalization module 24 then generates a pair (MTᵢⱼ, Sₖ) representing the jth marked-up/tagged portion of text M in document Tᵢ that is positive for a pre-defined event attribute Sₖ. The set of all such pairs P are then stored by the normalization module 24 in the data store 34.

In one embodiment, for each pre-defined event attribute Sₖ, the normalization module 24 identifies positive examples and negative examples from the set of training documents 36. The positive examples are all pairs in the set of pairs P that correspond to one of the pre-defined event attributes Sₖ. Negative examples are all pairs in P that do not correspond to the pre-defined event attribute Sₖ, but have a similar attribute type as Sₖ. For example, if Sₖ is a numeric dividend value, all other numeric values are identified as negative examples.

Referring back to FIG. 2, once positive and negative examples are determined, at step 54, the feature module 26 generates one or more document features for each of the identified positive and negative examples. In one embodiment, the feature module 26 generates one or more document features (e.g., numerical vectors) on a portion of unstructured text (e.g., the marked-up/tagged text) surrounding a potential (e.g., a candidate) event attribute of each positive and negative example. The size of the portion of unstructured text is user-configurable. For example, referring to the below example of unstructured text, the portion of unstructured text surrounding the candidate event attribute “0.45 p” is “Board is recommending, subject to shareholder approval, a total dividend for the year of 0.45 p per share (2009:0.4 p per share)”.

The feature module 26 of the present invention utilizes a plurality of feature generation schemas 38 (e.g., algorithms) to generate document features for positive and negative examples. For example, in one embodiment, the feature generation schemas include, but are not limited to, the following schemas: ‘Bag-of-Words’, ‘Distance-Farthest/Distance-Closest’, ‘Before-Or-After’, ‘Qualifier-Present’, ‘Delimiter-Present’, ‘Figure-Value-Threshold’, ‘N-Grams’, ‘Title-Words’, ‘Period-in-Context’, ‘Closest-Single-Matching-Tag’, and ‘Log-of-the-Value-for-Figure-based-Attributes’.

The feature module 26 uses the Bag-of-Words schema to generate a document feature for each unique word, phrase, or normalized text that occurs in a portion of unstructured text including the marked-up/tagged information, and assigns a feature value to the generated document feature based on a number of times each unique word, phrase, or normalized text, respectively, occurs in the portion of unstructured text. For example, referring to the before-mentioned example of unstructured text, unigrams extracted include ‘Board’, ‘is’, ‘recommending’, ‘subject’, etc.

The feature module 26 uses the Distance-Farthest/Distance-Closest schema to generate a document feature for marked-up/tagged information. In one embodiment, the feature module 26 compares the tagged information to a plurality of pre-defined text associated with the set of pre-defined event attributes, and then generates a document feature for the tagged information based on the comparison. The feature module 26 then assigns a feature value to the generated document feature representing a spatial distance between the marked-up/tagged information and a candidate attribute.

For example, referring to the before-mentioned example of unstructured text, if the words “recommending” and “dividend” are part of the pre-defined text associated with the set of pre-defined event attributes, feature values assigned to the generated document feature would be 11/21 and 5/21, where 11 and 5 are word distances from the candidate attribute ‘0.45 p’ and twenty-one (21) represents the number of words in the before-mentioned example of unstructured text.

The feature module 26 uses the Before-Or-After schema to generate a document feature for marked-up/tagged information that occurs in a list of pre-defined text associated with pre-defined event attributes. In one embodiment, the feature module 26 compares the marked-up/tagged information to a plurality of pre-defined text associated with the set of pre-defined event attributes, generates the document feature for the marked-up/tagged information based on the comparison, and then assigns a first feature value, for example a numeric one (1), to the generated document feature if the marked-up/tagged information is included in the plurality of pre-defined text and the marked-up/tagged information occurs after the candidate attribute in the portion of unstructured text. The feature module 26 assigns a second feature value, for example a negative one (−1), to the generated document feature if the marked-up/tagged information is included in the plurality of pre-defined text occurs before the at least one candidate attribute in the portion of unstructured text, and assigns a third feature value, for example a zero (0), to the generated document feature if the tagged information is not included in the plurality of pre-defined text.

For example, referring to the before-mentioned example of unstructured text, if the phrases “per share” and “recommending” are part of the pre-defined text associated with a figure event attribute, the feature module 26 assigns a feature value of one (1) and negative one (−1), respectively, as “per share” occurs in the example text after the figure candidate attribute and “recommending” occurs in the example text before the figure candidate attribute.

The feature module 26 uses the Qualifier-Present schema to generate a document feature for qualifying terms (e.g., terms that differentiate, characterize, or distinguish the candidate attribute) that occur in the portion of unstructured text. In one embodiment, the feature module 26 identifies qualifier text included in the portion of unstructured text, generates a document feature for the identified qualifier text, and then assigns a feature value to the generated document feature representing whether the identified qualifier text is included in a plurality of pre-defined qualifier text associated with the set of pre-defined event attributes.

For example, referring to the before-mentioned example of unstructured text, if the pre-defined qualifier text includes the words “total”, “final”, “interim” and “basic”, the feature module 26 may assign feature values to generated document features of one (1), zero (0), zero (0) and zero (0), respectively, as only the word “total” is present in the example unstructured text.

The feature module 26 uses the Delimiter-Present schema to generate a document feature for each delimiter (e.g., comma, colon, parenthesis, period, etc.) that occurs in the portion of unstructured text. In one embodiment, the feature module 26 identifies a delimiter included in the portion of unstructured text, generates a document feature for the identified delimiter, and then assigns a feature value to the generated document feature representing whether the identified delimiter is included in a plurality of pre-defined delimiters associated with the set of pre-defined event attributes.

The feature module 26 uses the Figure-Value-Threshold schema to generate document features for numerical event attributes. In one embodiment, the feature module 26 identifies a numerical event attribute included in the portion of unstructured text, generates a document feature for the identified numerical event attribute, compares the numerical event attribute to a pre-defined threshold value; and assigns a feature value to the generated document feature based on the comparison. The feature module 26 may assign a feature value of one (1) if the numerical event attribute does not exceed the threshold value and assign a feature value of zero (0) if the numerical event attribute exceeds the threshold value.

The feature module 26 uses the N-Grams schema to generate a document feature for each unique N-Gram (e.g., bi-gram, tri-gram, etc.) that occurs in the portion of unstructured text and uses the number of times the N-Gram occurs in the portion of unstructured text window as a document feature frequency. In one embodiment, the feature module 26 identifies each unique N-Gram included in the portion of unstructured text, generates a document feature for each of the identified N-Grams, and then assigns a feature value to the generated document feature based on a frequency each identified unique N-gram occurs in the portion of unstructured text.

For example, referring to the before-mentioned example of unstructured text and using Bi-grams, the feature module 26 using the N-Grams schema would generate the following as document features: “Board is”, “is recommending”, “per share”, etcetera.

The feature module 26 uses the Title-words schema to generate a document feature for marked-up/tagged information that occurs both in a title of the unstructured text and the portion of unstructured text. For example, in one embodiment, the feature module 26 generates a document feature for the marked-up/tagged information, and assigns a feature value to each generated document feature representing whether the tagged information is included in a title associated with the unstructured text document and also included in a plurality of pre-defined text associated with the set of pre-defined event attributes.

The feature module 26 uses the Period-in-Context schema to generate document features for period-dependent fact types, and assigns a feature value to generated document features based on whether a period identified from a document context (e.g., a document title or metadata) corresponds to the period specified in the portion of unstructured text. In one embodiment, the feature module 26 identifies a period-dependent attribute from a context of the unstructured text document, the context defined by one of a title associated with the unstructured text document and metadata associated with the unstructured text document, generates a document feature for the period-dependent attribute, and assigns a first feature value to the generated document feature if the period-dependent attribute is included in the portion of unstructured text.

The feature module 26 uses the Closest-Single-Matching-Tag schema to generate a document feature for marked-up/tagged information that occurs nearest to the candidate attribute, on its left of right respectively. For example, in one embodiment, the feature module 26 generates a document feature for marked-up/tagged information nearest to a candidate attribute included in the portion of unstructured text, and assigns a feature value to the generated document feature based on a numerical index of nearest tagged information to the at least one candidate attribute.

The feature module 26 uses the Log-of-the-Value-for-Figure-based-Attributes schema to generate feature values that represent the log of the actual value of figure-based candidate attributes. In one embodiment, the feature module 26 identifies a numerical event attribute included in the portion of unstructured text, generates a document feature for the identified numerical event attribute, and assigns a feature value to the generated document feature based on a logarithm of the numeric event attribute.

In one embodiment, once a plurality of document features are generated, the feature module 26 normalizes the feature values obtained using some or all of the above-described feature generation schemas. In one embodiment, the feature module 26 normalizes the assigned feature values using Term Frequency-Inverse Document Frequency (TF-IDF). In another embodiment, the feature module 26 normalizes assigned feature values using other normalization schemes.

Referring to FIG. 2, once the feature module 26 generates the document features for positive and negative examples, at step 56, the classification module 28 uses the positive and negative examples to train multiple binary classifiers for each pre-defined event attribute type. In one embodiment, each of the binary classifiers uses a different classification algorithm, set of generated document features, and/or a different subset of training documents. Next, at step 58, for each trained classifier, the classification module 28 trains a probability estimation model using one of several existing schemes. For example, in one embodiment, the classification module 28 trains the probability estimation model using a Isotonic Regression technique. In another embodiment, the classification module 28 trains the probability estimation model using a probability estimation scheme.

Next, at step 60, for each event in the set of events 42, the confidence module 60 constructs a confidence model. In one embodiment, the confidence module 60 constructs the confidence model by first computing n-gram counts, n being configurable, for each unique n-gram that occurs in any of the portions of unstructured text in the set of training documents 36 that correspond to pre-defined event attributes in the set of events 42. Next, the confidence module 60 assigns a confidence score to each portion of the unstructured text. The confidence score being an average of all n-gram counts associated with each portion of the unstructured text. Next, the confidence module 60 computes statistical properties for each of the portions of unstructured text using the confidence scores. The statistical properties include, but are limited to, an average, maximum, minimum, and standard deviation of all confidence score. The confidence module 60 then generates a first corpus of documents and a second corpus of documents based on these statistical properties. The first corpus includes portions of unstructured text from the set of training documents 36 that are a true positive for pre-defined event attributes. The second corpus of documents includes portions of unstructured text from the set of training documents 36 that are false positive instances for pre-defined event attributes.

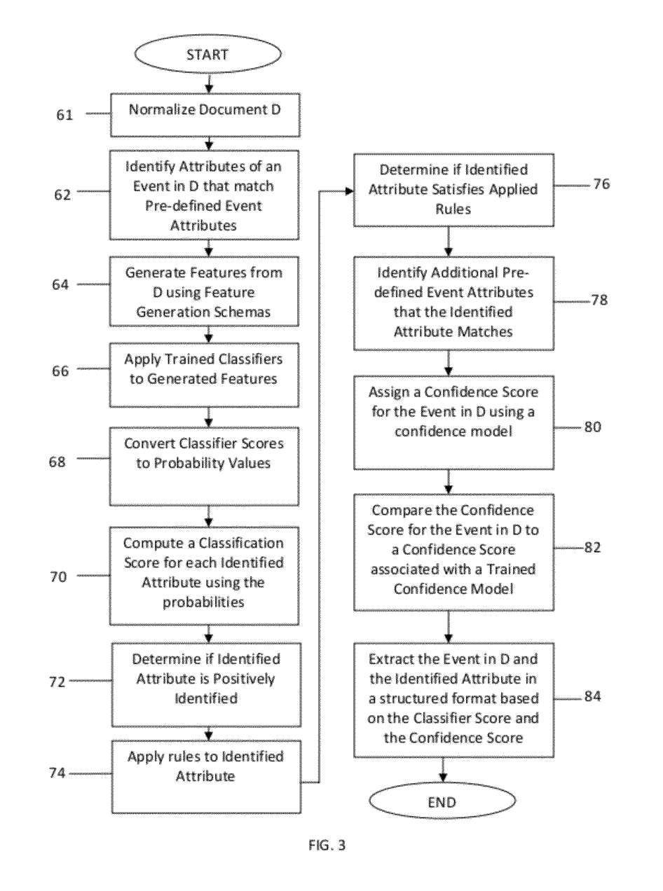

Referring now to FIG. 3, an exemplary method for representing information from an unstructured text document is disclosed. As shown in the FIG. 3 example, at step 61, the normalization module 24 normalizes at least one of the set of unstructured documents 44. As described previously, the set of unstructured documents may be an unstructured text document D received over a real-time news feed. In one embodiment, the normalization module 24 normalizes document D by identifying a candidate attribute included in the unstructured text document, associating a unique identifier with the candidate attribute, comparing the candidate attribute to each of the set of pre-defined event attributes, and storing the candidate attribute, the unique identifier, and at least one of the pre-defined event attributes based on the comparison. The candidate attributes may be keywords, sequences of letters, numbers, and characters, which are defined in a financial domain.

Next, at step 62, the normalization module 24 identifies attributes of an event included in the unstructured text document D. Each of the identified attributes is at least similar to at least one event attribute included in a set of pre-defined event attributes defined in the set of events 42. Next, at step 64, the feature module 26 generates document features from the unstructured text document using one or more of the feature generation schemas discussed previously.

For example, in one embodiment, the feature module 26 may apply the Bag-of-Words feature generation schema by generating a document feature for each unique word, phrase, or normalized text occurring in a portion of the unstructured text document, and assigning a feature value to the generated document feature based on a number of times each of the word, phrase, or normalized text, respectively, occurs in the portion of the unstructured text document.

The feature module 26 may also apply the Distance-Farthest/Distance-Closest feature generation schema by identifying text neighboring one of the identified attributes from a plurality of pre-defined text associated with the set of pre-defined event attributes, generating a document feature for the identified neighboring text, and assigning a feature value to the generated document feature representing a spatial distance between the identified neighboring text and the one of the identified attributes.

In one embodiment, for example, the feature module 26 may apply the Before-Or-After feature generation schema by identifying text neighboring one of the identified attributes, generating a document feature for the identified neighboring text, assigning a first feature value to the generated document feature if the identified neighboring text is included in a plurality of pre-defined text associated with the set of pre-defined event attributes and the identified neighboring text occurs after the identified attribute in the portion of unstructured text.

The feature module 26 may also assign a second feature value to the generated document feature if the identified neighboring text is included in the plurality of pre-defined text associated with the set of pre-defined event attributes and the identified neighboring text occurs before the identified attribute in the portion of unstructured text. A third feature value may be assigned by the feature module 26 to the generated document feature if the identified neighboring text is not included in the plurality of pre-defined text associated with the set of pre-defined event attributes.

The feature module 26 may apply the Qualifier-Present feature generation schema by identifying qualifier text included in the portion of unstructured text, generating a document feature for the identified qualifier text, and assigning a feature value to the generated document feature representing whether the identified qualifier text is included in a plurality of pre-defined qualifier text associated with the set of pre-defined event attributes.

In one embodiment, the feature module 26 may apply the Delimiter-Present feature generation schema by identifying a delimiter included in the portion of unstructured text, generating a document feature for the identified delimiter, and assigning a feature value to the generated document feature representing whether the identified delimiter is included in a plurality of pre-defined delimiters associated with the set of pre-defined event attributes.

The feature module 26 may apply the Figure-Value-Threshold feature generation schema by identifying a numerical event attribute included in the portion of unstructured text, generating a document feature for the identified numerical event attribute, comparing the numerical event attribute to a pre-defined threshold value, and assigning a feature value to the generated document feature based on the comparison.

In one embodiment, the feature module 26 may apply the N-Grams feature generation schema by identifying each unique N-Gram included in the portion of unstructured text, generating a document feature for each of the identified N-Grams, and assigning a feature value to the generated document feature based on a frequency each identified unique N-gram occurs in the portion of unstructured text.

The feature module 26 may apply the Title-words feature generation schema by identifying text neighboring one of the identified attributes, generating a document feature for the identified neighboring text, and assigning a feature value to the generated document feature representing whether the identified neighboring text is included in a title associated with the unstructured text document and a plurality of pre-defined text associated with the set of pre-defined event attributes.

In one embodiment, for example, the feature module 26 may apply the Period-in-Context feature generation schema by identifying a period-dependent attribute from a context of the unstructured text document, the context defined by a title associated with the unstructured text document or metadata associated with the unstructured text document, generating a document feature for the period-dependent attribute, and assigning a first feature value to the generated document feature if the period-dependent attribute is included in the portion of unstructured text.

The feature module 26 may apply the Closest-Single-Matching-Tag feature generation schema by generating a document feature for neighboring text nearest to the identified attribute in the portion of unstructured text, and assigning a first feature value to the generated document feature based on a numerical index of the nearest neighboring text to the identified attribute.

In yet another embodiment, the feature module 26 may apply the Log of the Value for Figure-based-Attributes feature generation schema by identifying a numerical event attribute included in the portion of unstructured text, generating a document feature for the identified numerical event attribute, and assigning a feature value to the generated document feature based on a logarithm of the numerical event attribute.

Next, as shown in step 66 of FIG. 3, the classification module 28 applies at least one of a plurality of classifiers to each of the generated document features. The at least one classifier previously trained using a pre-defined event attribute corresponding to the identified event attribute. Next, at step 68, the classification module 28 computes a probability value from a classifier score generated by the at least one classifier using one of the previously trained probability estimation models. The computed probability value indicating a likelihood of the identified event attribute corresponding to one of the set of pre-defined event attributes.

At shown in step 70, the classification module 28 next computes a classification score for each identified attribute in D using the computed probability values. In one embodiment, the classification module 28 computes the classification score by combining the results of classifiers. For example, in one embodiment, the classification module 28 normalizes and/or converts raw scores assigned by the classifiers to probabilities using a normalization or probability estimation scheme. In one embodiment, the classification module 28 uses isotonic regression in normalizing the raw scores, but other estimation schemes known in the art may also be utilized by the classification module 28. These normalized scores are then combined into a single score as a weighted linear combination. In one embodiment, the classification module 28 determines the weights empirically. In another embodiment, the classification module 28 determines the weights by applying cross validation on each identified attribute.

Next, at step 72, the classification module 28 determines whether the identified attribute in D has been positively identified as an attribute in the set of pre-defined event attributes. If the classification module 28 determines that the identified in D is positively identified, at step 74, the classification module applies at least one of the set of pre-defined rules 40 to the identified attribute. Each one of the set of pre-defined rules 40 identifies patterns in portions of text neighboring the event in D.

For example, referring to the below example portion of text neighboring the figure event attribute of “1.1 p per share”, as identified by a classifier:
“A dividend of Lip per share totaling §2.1 m in respect of the period ended 1 Oct. 2006 was paid in this period”
   an example pre-defined rule is set forth below:
   “.*candidateToken.*(was\previously)[ ]+(paid\proposed\declared\recommended).*”.
   In one embodiment, the example pre-defined rule is a regular expression rule that identifies numerical figures for dividends that have been paid or declared earlier and are hence not considered news by the system. In one embodiment, the pre-defined rule returns a value of true if the figure event attribute (1.1 p per share) is followed by the words “was paid, was declared, was proposed or was recommended”.

Conditional rules may also be included in the set of pre-defined rules 40. For example, in one embodiment, dates are identified in the context of identified attributes and are compared to the date or period of published news text. If the date belongs to a previous period, then the rule returns true, indicating that the dates relate to older information.

Next, at step 76, if the classification module 28 determines that the identified attribute satisfies one or more applied rules, at step 78, the classification module 28 identifies any additional pre-defined event attributes that correspond to the identified attribute.

Next, at step 80, the confidence module 30 assigns a confidence score for the event in D using one of the previously trained confidence models. Once the confidence score is assigned, at step 82, the confidence module 30 compares the confidence score assigned to the event with a confidence score associated with a trained confidence model. Based on the comparison, at step 84, the extraction module 32 represents the event from the unstructured text document D and one or more identified attribute in a structured format based on the classifier score and the confidence score

In one embodiment, the confidence module 30 computes the confidence score associated with the event by averaging all N-gram counts derived from a portion of unstructured text neighboring and including the event in D. The confidence module 30 then compares the computed confidence score associated with the event to a prior-estimated average associated with at least one event attribute included in the set of pre-defined event attributes. In one embodiment, the confidence module 30 determines how many standard deviations above or below the prior-estimated average the computed confidence score is. The confidence module 30 then assigns the confidence score to the event based on the comparison.

In another embodiment, the confidence module 30 determines, if the confidence score exceeds a threshold value, whether an identified event attribute included in the portion of unstructured text is likely to be identified by a model M trained on the before-mentioned first corpus or second corpus of documents. As discussed previously, the first corpus of documents includes unstructured text from the set of training documents 36 previously determined to be a true positive for the event attribute and the second corpus of documents includes portions of unstructured text from the set of training documents 36 that are false positive instances for pre-defined event attributes.

In one embodiment, the confidence module 30 computes the likelihood of the event attribute P_{M}(c) being identified using the first corpus or the second corpus using the following formula:

$${P}_{M} ( c ) = {\sum }_{∀ n \text{-} gram n ∈ c} log ( {pgen}_{M} ( n ) )$$

where pgen_{M}(n) is a probability of a model M trained on the first corpus of unstructured text to generate the n-gram n and is computed by:

$${pgen}_{M} ( n ) = \frac{S ( {count}_{M} ( n ) )}{{\sum }_{∀ i ∈ M} count ( i )}$$

where S( ) is a Good-Turing smoothing function to account for 0 occurrence n-grams.

If the computed likelihood of the event attribute is less than a threshold probability value associated with the model M trained on the first corpus of unstructured text, the confidence module 30 diminishes the value of the computed confidence score. Otherwise, the confidence module 30 maintains the value of the computed confidence score.

In yet another the embodiment, the confidence module 30 increases the computed confidence score for the event attribute if a binary classifier classifies the portion of unstructured text as being positive for the event attribute, and decreases the computed confidence score for the candidate attribute if the binary classifier classifies the portion of unstructured text as being negative for the event attribute.

Various features of the system may be implemented in hardware, software, or a combination of hardware and software. For example, some features of the system may be implemented in one or more computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

What is claimed is:

1. A method comprising:
identifying attributes of an event included in an unstructured text document, each of the identified attributes similar to at least one event attribute included in a set of pre-defined event attributes;
generating document features for each of the identified attributes;
applying at least one of a plurality of classifiers to each of the generated document features, the at least one classifier previously trained using the pre-defined event attribute corresponding to the identified event attribute;
computing a probability value from a classifier score generated by the at least one classifier using a probability estimation model, the probability value indicating a likelihood of the identified event attribute corresponding to one of the set of pre-defined event attributes;
combining a plurality of computed probability values associated with the identified attributes to generate a classification score; and
representing, from the unstructured text document, the event and the identified attributes into a structured format based at least in part on the classification score.

2. The method of claim 1, further comprising:
applying at least one rule from a plurality of pre-defined rules to each of the identified attributes; and
determining whether each of the identified attributes is similar to at least one event attribute included in the set of predefined attributes based on the at least one rule.

3. The method of claim 1, further comprising:
assigning a confidence score to the event using at least one confidence model;
comparing the confidence score associated with the event to a confidence score associated with a trained confidence model; and
representing, from the unstructured text document, the event and identified attributes in the structured format based on the comparison.

4. The method of claim 3, wherein identifying the attributes of the event comprises normalizing the unstructured text document.

5. The method of claim 4, wherein normalizing the unstructured text document comprises:
identifying a candidate attribute included in the unstructured text document;
associating a unique identifier with the candidate attribute;
comparing the candidate attribute to each of the set of pre-defined event attributes; and
storing the candidate attribute, the unique identifier, and at least one of the pre-defined event attributes based on the comparison.

6. The method of claim 5, wherein the candidate attributes are one of keywords, sequences of letters, numbers, and characters, the candidate attributes defined in a financial domain.

7. The method of claim 3, further comprising:
identifying a portion of unstructured text neighboring and including the event, the portion of unstructured text having a user-configurable text size;
computing the confidence score associated with the event by averaging all N-gram counts derived from the portion of unstructured text;
comparing the computed confidence score associated with the event to a prior-estimated average associated with the at least one event attribute included in the set of pre-defined event attributes; and
assigning the confidence score to the event based on the comparison.

8. The method of claim 7, further comprising determining, if the confidence score exceeds a threshold value, whether a candidate attribute included in the portion of unstructured text is likely to be identified by a model M trained on a first corpus of unstructured text, the first corpus of unstructured text being a portion of unstructured text determined to be a true positive for the event attribute.

9. The method of claim 8, wherein the likelihood of the candidate attribute being identified by the model M trained on the first corpus of unstructured text P_{M}(c) is computed by:
$${P}_{M} ( c ) = {\sum }_{∀ n \text{-} gram n ∈ c} log ( {pgen}_{M} ( n ) )$$
where pgen_{M}(n) is a probability of the model M trained on the first corpus of unstructured text to generate the n-gram n and is computed by:
$${pgen}_{M} ( n ) = \frac{S ( {count}_{M} ( n ) )}{{\sum }_{∀ i ∈ M} count ( i )}$$
where S( ) is a Good-Turing smoothing function to account for 0 occurrence n-grams.

10. The method of claim 9, wherein if the computed likelihood of the candidate attribute is less than a threshold probability value associated with the model trained on the first corpus of unstructured text, diminishing the value of the computed confidence score.

11. The method of claim 9, further comprising:
applying a binary classifier to the portion of unstructured text;
increasing the computed confidence score for the candidate attribute if the binary classifier classifies the portion of unstructured text as being positive for the event attribute; and
decreasing the computed confidence score for the candidate attribute if the binary classifier classifies the portion of unstructured text as being negative for the event attribute.

12. The method of claim 1, wherein the probability estimation model uses isotonic regression or a probability estimation scheme and the generated classification score is a weighted linear combination of the plurality of computed probability values.

13. The method of claim 1, wherein generating the document features for each of the identified attributes comprises applying a plurality of feature generation schemas to the identified attributes.

14. The method of claim 13, comprising selecting the plurality of feature generation schemas from at least the following group of schemas: ‘Bag-of-Words’, ‘Distance-Farthest/Distance-Closest’, ‘Before-Or-After’, ‘Qualifier-Present’, ‘Delimiter-Present’, ‘Figure-Value-Threshold’, ‘N-Grams’, ‘Title-Words’, ‘Period-in-Context’, ‘Closest-Single-Matching-Tag’, and ‘Log of the Value for Figure-based Attributes’.

15. The method of claim 14, wherein applying the Bag-of-Words feature generation schema comprises:
generating a document feature for each unique word, phrase, or normalized text occurring in the portion of unstructured text; and
assigning a feature value to the generated document feature based on a number of times each of the word, phrase, or normalized text, respectively, occurs in the portion of unstructured text.

16. The method of claim 14, wherein applying the Distance-Farthest/Distance-Closest feature generation schema comprises:
identifying text neighboring one of the identified attributes from a plurality of pre-defined text associated with the set of pre-defined event attributes;
generating a document feature for the identified neighboring text; and
assigning a feature value to the generated document feature representing a spatial distance between the identified neighboring text and the one of the identified attributes.

17. The method of claim 14, wherein applying the Before-Or-After feature generation schema comprises:
identifying text neighboring one of the identified attributes;
generating a document feature for the identified neighboring text;
assigning a first feature value to the generated document feature if the identified neighboring text is included in a plurality of pre-defined text associated with the set of pre-defined event attributes and the identified neighboring text occurs after the identified attribute in the portion of unstructured text;
assigning a second feature value to the generated document feature if the identified neighboring text is included in the plurality of pre-defined text associated with the set of pre-defined event attributes and the identified neighboring text occurs before the identified attribute in the portion of unstructured text; and
assigning a third feature value to the generated document feature if the identified neighboring text is not included in the plurality of pre-defined text associated with the set of pre-defined event attributes.

18. The method of claim 14, wherein applying the Qualifier-Present feature generation schema comprises:
identifying qualifier text included in the portion of unstructured text;
generating a document feature for the identified qualifier text; and
assigning a feature value to the generated document feature representing whether the identified qualifier text is included in a plurality of pre-defined qualifier text associated with the set of pre-defined event attributes.

19. The method of claim 14, wherein applying the Delimiter-Present feature generation schema comprises:
identifying a delimiter included in the portion of unstructured text;
generating a document feature for the identified delimiter; and
assigning a feature value to the generated document feature representing whether the identified delimiter is included in a plurality of pre-defined delimiters associated with the set of pre-defined event attributes.

20. The method of claim 14, wherein applying the Figure-Value Threshold feature generation schema comprises:
identifying a numerical event attribute included in the portion of unstructured text;
generating a document feature for the identified numerical event attribute;
comparing the numerical event attribute to a pre-defined threshold value; and
assigning a feature value to the generated document feature based on the comparison.

21. The method of claim 14, wherein applying the N-Grams feature generation schema comprises:
identifying each unique N-Gram included in the portion of unstructured text;
generating a document feature for each of the identified N-Grams
assigning a feature value to the generated document feature based on a frequency each identified unique N-gram occurs in the portion of unstructured text.

22. The method of claim 14, wherein applying the Title-words feature generation schema comprises:
identifying text neighboring one of the identified attributes;
generating a document feature for the identified neighboring text; and
assigning a feature value to the generated document feature representing whether the identified neighboring text is included in a title associated with the unstructured text document and a plurality of pre-defined text associated with the set of pre-defined event attributes.

23. The method of claim 14, wherein applying the Period-in-Context feature generation schema comprises:
identifying a period-dependent attribute from a context of the unstructured text document, the context defined by a title associated with the unstructured text document or metadata associated with the unstructured text document;
generating a document feature for the period-dependent attribute; and
assigning a first feature value to the generated document feature if the period-dependent attribute is included in the portion of unstructured text.

24. The method of claim 14, wherein applying the Closest-Single-Matching-Tag feature generation schema comprises:
generating a document feature for neighboring text nearest to the identified attribute in the portion of unstructured text; and
assigning a first feature value to the generated document feature based on a numerical index of the nearest neighboring text to the identified attribute.

25. The method of claim 14, wherein applying the Log-of-the-Value-for-Figure-based-Attributes feature generation schema comprises:
identifying a numerical event attribute included in the portion of unstructured text;
generating a document feature for the identified numerical event attribute; and
assigning a feature value to the generated document feature based on a logarithm of the numerical event attribute.

26. The method of claim 1, further comprising training the plurality of classifiers using a plurality of feature generation schemas, a set of training documents each including at least one candidate event, and the set of pre-defined event attributes.

27. The method of claim 26, comprising:
normalizing each document of the set of training documents by tagging a plurality of information included in each training document, the plurality of tagged information associated with a financial domain and each one of the plurality of tagged information assigned a unique identifier within each training document;
receiving a signal from a user interface indicating that at least one of the plurality of tagged information corresponds to one of the set of pre-defined event attributes; and
storing the unique identifier and the corresponding pre-defined event attribute as a pair in response to receiving the signal.

28. The method of claim 27, further comprising providing the user interface for displaying each normalized document and the tagged plurality of information.

29. The method of claim 27, comprising:
comparing the corresponding event attribute included in the pair to each one of the set of pre-defined event attributes to; and
determining whether the pair represents a positive example or a negative example for each of the pre-defined event attributes based on the comparison.

30. The method of claim 29, comprising generating at least one document feature for each determined positive example and negative example by applying a plurality of feature generation schemas to at least a portion of the tagged information neighboring the at least one candidate event, the portion of the tagged information having a user-configurable text size.

31. The method of claim 30, wherein generating the at least one document feature for each determined positive example and negative example comprises applying a plurality of feature generation schemas to the positive example and the negative example, respectively.

32. The method of claim 31, comprising selecting the plurality of feature generation schemas from at least the following group of schemas: ‘Bag-of-Words’, ‘Distance-Farthest/Distance-Closest’, ‘Before-Or-After’, ‘Qualifier-Present’, ‘Delimiter-Present’, ‘Figure-Value-Threshold’, ‘N-Grams’, ‘Title-Words’, ‘Period-in-Context’, ‘Closest-Single-Matching-Tag’, and ‘Log of the Value for Figure-based Attributes’.

33. The method of claim 32, wherein applying the Bag-of-Words feature generation schema comprises:
generating a document feature for each unique word, phrase, or normalized text occurring in a portion of unstructured text including the tagged information; and
assigning a feature value to the generated document feature based on a number of times each of the word, phrase, or normalized text, respectively, occurs in the portion of unstructured text including the tagged information.

34. The method of claim 32, wherein applying the Distance-Farthest/Distance-Closest feature generation schema comprises:
comparing the tagged information to a plurality of pre-defined text associated with the set of pre-defined event attributes;
generating a document feature for the tagged information based on the comparison; and
assigning a feature value to the generated document feature representing a spatial distance between the tagged information and the at least one candidate attribute.

35. The method of claim 32, wherein applying the Before-Or-After feature generation schema comprises:
comparing the tagged information to a plurality of pre-defined text associated with the set of pre-defined event attributes;
generating a document feature for the tagged information based on the comparison;
assigning a first feature value to the generated document feature if the tagged information is included in a plurality of pre-defined text associated with the set of pre-defined event attributes and the tagged information occurs after the at least one candidate attribute in the portion of unstructured text;
assigning a second feature value to the generated document feature if the tagged information is included in the plurality of pre-defined text associated with the set of pre-defined event attributes and the tagged information occurs before the at least one candidate attribute in the portion of unstructured text; and
assigning a third feature value to the generated document feature if the tagged information is not included in the plurality of pre-defined text associated with the set of pre-defined event attributes.

36. The method of claim 32, wherein applying the Qualifier-Present feature generation schema comprises:
identifying qualifier text included in the portion of unstructured text;
generating a document feature for the identified qualifier text; and
assigning a feature value to the generated document feature representing whether the identified qualifier text is included in a plurality of pre-defined qualifier text associated with the set of pre-defined event attributes.

37. The method of claim 32, wherein applying the Delimiter-Present feature generation schema comprises:
identifying a delimiter included in the portion of unstructured text;
generating a document feature for the identified delimiter; and
assigning a feature value to the generated document feature representing whether the identified delimiter is included in a plurality of pre-defined delimiters associated with the set of pre-defined event attributes.

38. The method of claim 32, wherein applying the Figure-Value-Threshold feature generation schema comprises:
identifying a numerical event attribute included in the portion of unstructured text;
generating a document feature for the identified numerical event attribute;
comparing the numerical event attribute to a pre-defined threshold value; and
assigning a feature value to the generated document feature based on the comparison.

39. The method of claim 32, wherein applying the N-Grams feature generation schema comprises:
identifying each unique N-Gram included in the portion of unstructured text;
generating a document feature for each of the identified N-Grams
assigning a feature value to the generated document feature based on a frequency each identified unique N-gram occurs in the portion of unstructured text.

40. The method of claim 32, wherein applying the Title-words feature generation schema comprises:
generating a document feature for the tagged information; and
assigning a feature value to the generated document feature representing whether the tagged information is included in a title associated with the unstructured text document and included in a plurality of pre-defined text associated with the set of pre-defined event attributes.

41. The method of claim 32, wherein applying the Period-in-Context feature generation schema comprises:
identifying a period-dependent attribute from a context of the unstructured text document, the context defined by one of a title associated with the unstructured text document and metadata associated with the unstructured text document;
generating a document feature for the period-dependent attribute; and
assigning a first feature value to the generated document feature if the period-dependent attribute is included in the portion of unstructured text.

42. The method of claim 32, wherein applying the Closest-Single-Matching-Tag feature generation schema comprises:
generating a document feature for tagged information nearest to the at least one candidate attribute in the portion of unstructured text; and
assigning a first feature value to the generated document feature based on a numerical index of nearest tagged information to the at least one candidate attribute.

43. The method of claim 32, wherein applying the Log of the Value for Figure-based Attributes feature generation schema comprises:
identifying a numerical event attribute included in the portion of unstructured text;
generating a document feature for the identified numerical event attribute; and
assigning a feature value to the generated document feature based on a logarithm of the numeric al event attribute.

44. A system comprising:
a server including a processor and memory storing instructions that, in response to receiving a first request for access to a service, cause the processor to:
identify attributes of an event included in an unstructured text document, each of the identified attributes similar to at least one event attribute included in the set of pre-defined event attributes;
generate document features for each of the identified attributes;
apply at least one of the plurality of classifiers to each of the generated document features, the at least one classifier previously trained using the pre-defined event attribute corresponding to the identified event attribute;
compute a probability value from a classifier score generated by the at least one classifier using a probability estimation model, the probability value indicating a likelihood of the identified event attribute corresponding to one of the set of pre-defined event attributes;
combine a plurality of computed probability values associated with the identified attributes to generate a classification score; and
extract, from the unstructured text document, the event and the identified attributes into a structured format based at least in part on the classification score.

45. The system of claim 44, wherein the memory stores instructions that, in response to receiving the first request, cause the processor to:
apply at least one rule from a plurality of pre-defined rules to each of the identified attributes; and
determine whether each of the identified attributes is similar to at least one event attribute included in the set of predefined attributes based on the at least one rule.

46. The system of claim 44, wherein the memory stores instructions that, in response to receiving the first request, cause the processor to:
assign a confidence score to the event using at least one confidence model;
compare the confidence score associated with the event to a confidence score associated with a trained confidence model; and
extract, from the unstructured text document, the event and identified attributes in the structured format based on the comparison.

47. The system of claim 46, wherein the memory stores instructions that, in response to receiving the first request, cause the processor to normalize the unstructured text document.

48. The system of claim 47, wherein the memory stores instructions that, in response to receiving the first request, cause the processor to:
identify a candidate attribute included in the unstructured text document;
associate a unique identifier with the candidate attribute;
compare the candidate attribute to each of the set of pre-defined event attributes; and
store the candidate attribute, the unique identifier, and at least one of the pre-defined event attributes based on the comparison.

49. The system of claim 48, wherein the candidate attributes are one of keywords, sequence of letters, numbers and characters, the candidate attributes defined in a financial domain.

50. The system of claim 46, wherein the memory stores instructions that, in response to receiving the first request, cause the processor to:
identify a portion of unstructured text neighboring and including the event, the portion of unstructured text having a user-configurable text size;
compute the confidence score associated with the event by averaging all N-gram counts derived from the portion of unstructured text;
compare the computed confidence score associated with the event to a prior-estimated average associated with the at least one event attribute included in the set of pre-defined event attributes; and
assign the confidence score to the event based on the comparison.

51. The system of claim 50, wherein the memory stores instructions that, in response to receiving the first request, cause the processor to determine, if the confidence score exceeds a threshold value, whether a candidate attribute included in the portion of unstructured text is likely to be identified by a model M trained on a first corpus of unstructured text, the first corpus of unstructured text being a portion of unstructured text determined to be a true positive for the event attribute.

52. The system of claim 51, wherein the memory stores instructions that, in response to receiving the first request, cause the processor to compute the likelihood of the candidate attribute being identified by the model M trained on the first corpus of unstructured text P_{M}(c) by:
$${P}_{M} ( c ) = {\sum }_{∀ n \text{-} gram n ∈ c} log ( {pgen}_{M} ( n ) )$$
where pgen_{M}(n) is a probability of the model M trained on the first corpus of unstructured text to generate the n-gram n and is computed by:
$${pgen}_{M} ( n ) = \frac{S ( {count}_{M} ( n ) )}{{\sum }_{∀ i ∈ M} count ( i )}$$
where S( ) is a Good-Turing smoothing function to account for 0 occurrence n-grams.

53. The system of claim 52, wherein the memory stores instructions that, in response to receiving the first request, cause the processor to diminish the value of the computed confidence score if the computed likelihood of the candidate attribute is less than a threshold probability value associated with the model trained on the first corpus of unstructured text, diminishing the value of the computed confidence score.

54. The system of claim 52, wherein the memory stores instructions that, in response to receiving the first request, cause the processor to:
apply a binary classifier to the portion of unstructured text;
increase the computed confidence score for the candidate attribute if the binary classifier classifies the portion of unstructured text as being positive for the event attribute; and
decrease the computed confidence score for the candidate attribute if the binary classifier classifies the portion of unstructured text as being negative for the event attribute.

55. The system of claim 44, wherein the probability estimation model uses isotonic regression or a probability estimation scheme and the generated classification score is a weighted linear combination of the plurality of computed probability values.

56. The system of claim 44, wherein the memory stores instructions that, in response to receiving the first request, cause the processor to apply a plurality of feature generation schemas to the identified attributes to generate the features for each of the identified attributes comprises applying a plurality of feature generation schemas to the identified attributes.

57. The system of claim 56, wherein the memory stores instructions that, in response to receiving the first request, cause the processor to select the plurality of feature generation schemas from at least the following group of schemas: ‘Bag-of-Words’, ‘Distance-Farthest/Distance-Closest’, ‘Before-Or-After’, ‘Qualifier-Present’, ‘Delimiter-Present’, ‘Figure-Value-Threshold’, ‘N-Grams’, ‘Title-Words’, ‘Period-in-Context’, ‘Closest-Single-Matching-Tag’, and ‘Log of the Value for Figure-based Attributes’.

58. The system of claim 57, wherein the memory stores instructions that, in response to receiving the first request, cause the processor to:
generate a document feature for each unique word, phrase, or normalized text occurring in the portion of unstructured text; and
assign a feature value to the generated document feature based on a number of times each of the word, phrase, or normalized text, respectively, occurs in the portion of unstructured text.

59. The system of claim 57, wherein the memory stores instructions that, in response to receiving the first request, cause the processor to:
identify text neighboring one of the identified attributes from a plurality of pre-defined text associated with the set of pre-defined event attributes;
generate a document feature for the identified neighboring text; and
assign a feature value to the generated document feature representing a spatial distance between the identified neighboring text and the one of the identified attributes.

60. The system of claim 57, wherein the memory stores instructions that, in response to receiving the first request, cause the processor to:
identify text neighboring one of the identified attributes;
generate a document feature for the identified neighboring text;
assign a first feature value to the generated document feature if the identified neighboring text is included in a plurality of pre-defined text associated with the set of pre-defined event attributes and the identified neighboring text occurs after the identified attribute in the portion of unstructured text;
assign a second feature value to the generated document feature if the identified neighboring text is included in the plurality of pre-defined text associated with the set of pre-defined event attributes and the identified neighboring text occurs before the identified attribute in the portion of unstructured text; and
assign a third feature value to the generated document feature if the identified neighboring text is not included in the plurality of pre-defined text associated with the set of pre-defined event attributes.

61. The system of claim 57, wherein the memory stores instructions that, in response to receiving the first request, cause the processor to:
identify qualifier text included in the portion of unstructured text;
generate a document feature for the identified qualifier text; and
assign a feature value to the generated document feature representing whether the identified qualifier text is included in a plurality of pre-defined qualifier text associated with the set of pre-defined event attributes.

62. The system of claim 57, wherein the memory stores instructions that, in response to receiving the first request, cause the processor to:
identify a delimiter included in the portion of unstructured text;
generate a document feature for the identified delimiter; and
assign a feature value to the generated document feature representing whether the identified delimiter is included in a plurality of pre-defined delimiters associated with the set of pre-defined event attributes.

63. The system of claim 57, wherein the memory stores instructions that, in response to receiving the first request, cause the processor to:
identify a numerical event attribute included in the portion of unstructured text;
generate a document feature for the identified numerical event attribute;
compare the numerical event attribute to a pre-defined threshold value; and
assign a feature value to the generated document feature based on the comparison.

64. The system of claim 57, wherein the memory stores instructions that, in response to receiving the first request, cause the processor to:
identify each unique N-Gram included in the portion of unstructured text;
generate a document feature for each of the identified N-Grams
assign a feature value to the generated document feature based on a frequency each identified unique N-gram occurs in the portion of unstructured text.

65. The system of claim 57, wherein the memory stores instructions that, in response to receiving the first request, cause the processor to:
identify text neighboring one of the identified attributes;
generate a document feature for the identified neighboring text; and
assign a feature value to the generated document feature representing whether the identified neighboring text is included in a title associated with the unstructured text document and a plurality of pre-defined text associated with the set of pre-defined event attributes.

66. The system of claim 57, wherein the memory stores instructions that, in response to receiving the first request, cause the processor to:
identify a period-dependent attribute from a context of the unstructured text document, the context defined by a title associated with the unstructured text document or metadata associated with the unstructured text document;
generate a document feature for the period-dependent attribute; and
assign a first feature value to the generated document feature if the period-dependent attribute is included in the portion of unstructured text.

67. The system of claim 57, wherein the memory stores instructions that, in response to receiving the first request, cause the processor to:
generate a document feature for neighboring text nearest to the identified attribute in the portion of unstructured text; and
assign a first feature value to the generated document feature.

68. The system of claim 57, wherein the memory stores instructions that, in response to receiving the first request, cause the processor to:
identify a numerical event attribute included in the portion of unstructured text;
generate a document feature for the identified numerical event attribute; and
assign a feature value to the generated document feature based on a logarithm of the numeric al event attribute.

69. The system of claim 44, wherein the memory stores instructions that, in response to receiving a second request, cause the processor to train the plurality of classifiers using a plurality of feature generation schemas, a set of training documents each including at least one candidate event, and the set of pre-defined event attributes.

70. The system of claim 69, wherein the memory stores instructions that, in response to receiving the second request, cause the processor to:
normalize each document of the set of training documents by tagging a plurality of information included in each training document, the plurality of tagged information associated with a financial domain and each one of the plurality of tagged information assigned a unique identifier within each training document; and
store the unique identifier and the corresponding pre-defined event attribute as a pair in response to receiving a signal from a user interface indicating that at least one of the plurality of tagged information corresponds to one of the set of pre-defined event attributes.

71. The system of claim 71, wherein the memory stores instructions that, in response to receiving the second request, cause the processor to provide the user interface for displaying each normalized document and the tagged plurality of information.

72. The system of claim 70, wherein the memory stores instructions that, in response to receiving the second request, cause the processor to:
compare the corresponding event attribute included in the pair to each one of the set of pre-defined event attributes to; and
determine whether the pair represents a positive example or a negative example for each of the pre-defined event attributes based on the comparison.

73. The system of claim 72, wherein the memory stores instructions that, in response to receiving the second request, cause the processor to generate at least one document feature for each determined positive example and negative example by applying a plurality of feature generation schemas to at least a portion of the tagged information neighboring the at least one candidate event, the portion of the tagged information having a user-configurable text size.

74. The system of claim 73, wherein the memory stores instructions that, in response to receiving the second request, cause the processor to apply a plurality of feature generation schemas to the positive example and the negative example to generate the at least one feature for each determined positive example and negative example.

75. The system of claim 74, wherein the memory stores instructions that, in response to receiving the second request, cause the processor to select the plurality of feature generation schemas from at least the following group: ‘Bag-of-Words’, ‘Distance-Farthest/Distance-Closest’, ‘Before-Or-After’, ‘Qualifier-Present’, ‘Delimiter-Present’, ‘Figure-Value-Threshold’, ‘N-Grams’, ‘Title-Words’, ‘Period-in-Context’, ‘Closest-Single-Matching-Tag’, and ‘Log of the Value for Figure-based Attributes’.

76. The system of claim 75, wherein the memory stores instructions that, in response to receiving the second request, cause the processor to:
generate a document feature for each unique word, phrase, or normalized text occurring in a portion of unstructured text including the tagged information; and
assign a feature value to the generated document feature based on a number of times each of the word, phrase, or normalized text, respectively, occurs in the portion of unstructured text including the tagged information.

77. The system of claim 75, wherein the memory stores instructions that, in response to receiving the second request, cause the processor to:
compare the tagged information to a plurality of pre-defined text associated with the set of pre-defined event attributes;
generate a document feature for the tagged information based on the comparison; and
assign a feature value to the generated document feature representing a spatial distance between the tagged information and the at least one candidate attribute.

78. The system of claim 75, wherein the memory stores instructions that, in response to receiving the second request, cause the processor to:
compare the tagged information to a plurality of pre-defined text associated with the set of pre-defined event attributes;
generate a document feature for the tagged information based on the comparison;
assign a first feature value to the generated document feature if the tagged information is included in a plurality of pre-defined text associated with the set of pre-defined event attributes and the tagged information occurs after the at least one candidate attribute in the portion of unstructured text;
assign a second feature value to the generated document feature if the tagged information is included in the plurality of pre-defined text associated with the set of pre-defined event attributes and the tagged information occurs before the at least one candidate attribute in the portion of unstructured text; and
assign a third feature value to the generated document feature if the tagged information is not included in the plurality of pre-defined text associated with the set of pre-defined event attributes.

79. The system of claim 75, wherein the memory stores instructions that, in response to receiving the second request, cause the processor to:
identify qualifier text included in the portion of unstructured text;
generate a document feature for the identified qualifier text; and
assign a feature value to the generated document feature representing whether the identified qualifier text is included in a plurality of pre-defined qualifier text associated with the set of pre-defined event attributes.

80. The system of claim 75, wherein the memory stores instructions that, in response to receiving the first request, cause the processor to:
identify a delimiter included in the portion of unstructured text;
generate a document feature for the identified delimiter; and
assign a feature value to the generated document feature representing whether the identified delimiter is included in a plurality of pre-defined delimiters associated with the set of pre-defined event attributes.

81. The system of claim 75, wherein the memory stores instructions that, in response to receiving the second request, cause the processor to:
identify a numerical event attribute included in the portion of unstructured text;
generate a document feature for the identified numerical event attribute;
compare the numerical event attribute to a pre-defined threshold value; and
assign a feature value to the generated document feature based on the comparison.

82. The system of claim 75, wherein the memory stores instructions that, in response to receiving the second request, cause the processor to:
identify each unique N-Gram included in the portion of unstructured text;
generate a document feature for each of the identified N-Grams
assign a feature value to the generated document feature based on a frequency each identified unique N-gram occurs in the portion of unstructured text.

83. The system of claim 75, wherein the memory stores instructions that, in response to receiving the second request, cause the processor to:
generate a document feature for the tagged information; and
assign a feature value to the generated document feature representing whether the tagged information is included in a title associated with the unstructured text document and included in a plurality of pre-defined text associated with the set of pre-defined event attributes.

84. The system of claim 75, wherein the memory stores instructions that, in response to receiving the second request, cause the processor to:
identify a period-dependent attribute from a context of the unstructured text document, the context defined by one of a title associated with the unstructured text document and metadata associated with the unstructured text document;
generate a document feature for the period-dependent attribute; and
assign a first feature value to the generated document feature if the period-dependent attribute is included in the portion of unstructured text.

85. The system of claim 75, wherein the memory stores instructions that, in response to receiving the second request, cause the processor to:
generate a document feature for tagged information nearest to the at least one candidate attribute in the portion of unstructured text; and
assign a first feature value to the generated document feature.

86. The system of claim 75, wherein the memory stores instructions that, in response to receiving the second request, cause the processor to:
identify a numerical event attribute included in the portion of unstructured text;
generate a document feature for the identified numerical event attribute; and
assign a feature value to the generated document feature based on a logarithm of the numeric al event attribute.

87. A system comprising:
identifying means for identifying attributes of an event included in an unstructured text document, each of the identified attributes similar to at least one event attribute included in the set of pre-defined event attributes;
feature generation means for generating document features for each of the identified attributes;
applying means for applying at least one of the plurality of classifiers to each of the generated features, the at least one classifier previously trained using the pre-defined event attribute corresponding to the identified event attribute;
computing means for computing a probability value from a classifier score generated by the at least one classifier using a probability estimation model, the probability value indicating a likelihood of the identified event attribute corresponding to one of the set of pre-defined event attributes;
combining means for combining a plurality of computed probability values associated with the identified attributes to generate a classification score; and
representing means for representing, from the unstructured text document, the event and the identified attributes into a structured format based at least in part on the classification score.

88. A method comprising:
(1) accessing an unstructured text document to identify an event and a set of attributes associated with the event, the set of attributes being related to a set of predefined event attributes;
(2) generating a set of document features associated with the set of attributes, the set of document features having a higher number of set elements than the set of attributes;
(3) for a first document feature in the set of document features:
a. generating a first classifier score, the first classifier score being generated with a classifier having been previously trained using the set of predefined event attributes; and
b. based upon the first classifier score, computing a first probability value, using a probability estimation model, the first probability value indicating a likelihood that a first event attribute from the set of event attributes corresponds to the set of predefined event attributes;
(4) for a second document feature in the set of document features:
a. generating a second classifier score, the second classifier score being generated with the classifier; and
b. based upon the second classifier score, computing a second probability value using the probability estimation model, the second probability value indicating a likelihood that a second event attribute from the set of event attributes corresponds to the set of predefined event attributes;
(5) generating a classification score using a first probability value and the second probability value;
(6) based upon the classification score, representing from the unstructured text document, the event and the set of attributes into a structured format.
